(19) United States
(12) Patent Application Publication
(10) Pub. No.: US 2020/0217307 A1
(43) Pub. Date: Jul. 9, 2020

(54) MECHANICAL IMPULSE MOTOR BY COMPRESSED AIR COMPRESSION

(71) Applicant: Demóstenes Jesús VERGARA ALARCÓN, Santiago (PA)

(72) Inventor: Demóstenes Jesús VERGARA ALARCÓN, Santiago (PA)

(21) Appl. No.: 16/628,255

(22) PCT Filed: Aug. 10, 2017
(86) PCT No.: PCT/PA2017/000001

§ 371 Date: Jan. 2, 2020

(30) Foreign Application Priority Data
May 11, 2017 (PA) 91628-01

(51) Int. Cl. F03G 7/10; F16D 31/02

(52) U.S. Cl. CPC F03G 7/10; H02K 53/00; F16D 31/02

(57) ABSTRACT

This motor is powered by a compressor powered by a 3000w inverter, which sends compressed air flowing into the pistons, which produces a force-to-load advantage of the lever arms, coupled, which are coupled to the main shaft thus ensuring continuous rotation.

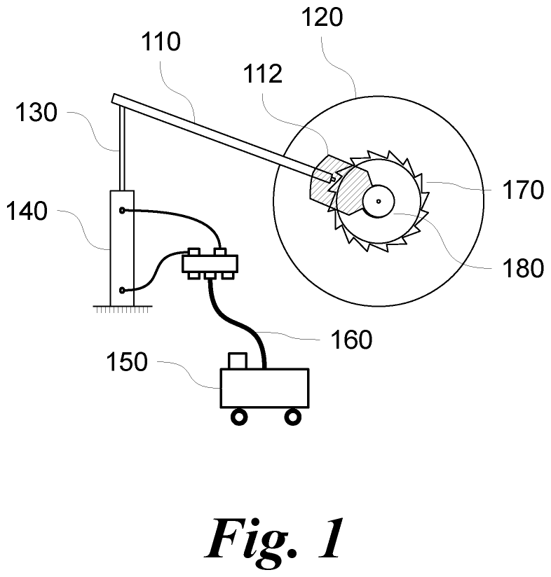

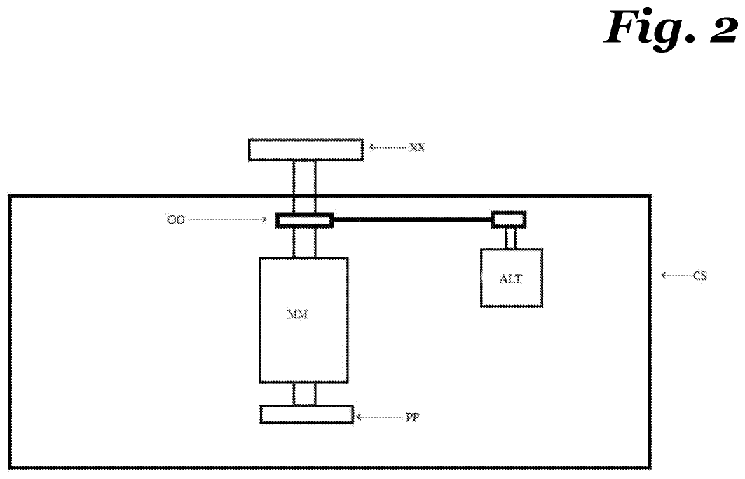

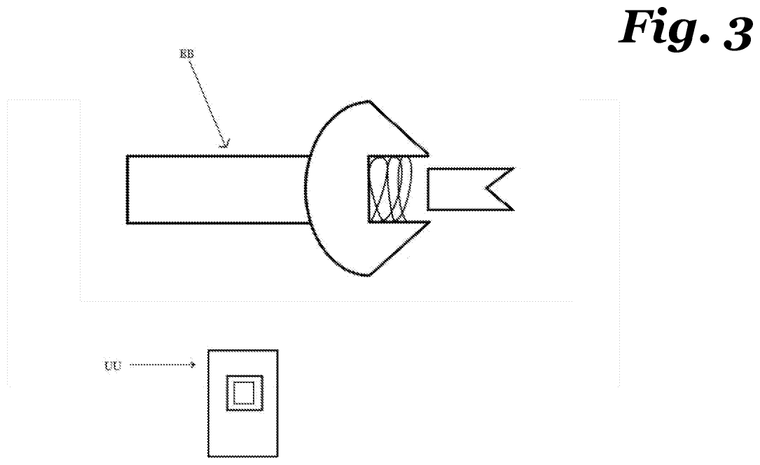

### FIELD OF INVENTION

This invention refers to the technical sector of mechanical impulse engines as it applies to the field of giving an incentive to commercial MEGAWATTS generators in order to produce clean, acclimatized and independent energy, without the need of using the hydrocarbons.

### BACKGROUND OF THE INVENTION

The problem is the use of hydrocarbons to move compressors, generators or water pumps. Especially the generation of clean, non-polluting energy is a global demand to improve the environment.

More precisely most engines are designed but dependent on fuels, something that increases pollution every day.

The previous art are inventions that do not contain a start mechanism with compressed air, for example, the invention U201130766 is an electric generator consisting of elements of revolution, where a main turning axis and radial arms, however, do not use ratchets and the same mechanism.

### DESCRIPTION OF THE INVENTION

The invention is able to move rotors of commercial generators, using mechanical advantages of torque with a ratchet designed to withstand large thrusts provided by two pneumatic pistons that are controlled by a pneumatic valve with solenoid powered by an air compressor. This system promotes a wider field in terms of its application as it can manipulate generators in the order of MEGAWATTS depending on the expansion of our ratchet mechanisms.

The generator rotor handling system is powered by a jet of compressed air that activates the pneumatic pistons, which in turn drive the ends of the torque levers (BB), which execute the ratchet mechanism. The ratchet mechanism is coupled to a pulley set, which increases the RPM, without minimizing the magnitude of the torque. The pulley coupled to the generator shows the magnitude of the RPM and torque variables required for efficient operation.

The function of the metal lining (SS) is of an innovative nature, which is to enclose the body of the pneumatic piston so that they are not lost by the impulse of when the piston reacts to its cause of movement. The ratchet mechanism is also innovative in nature because its design allows it to operate continuously and not intermittently like traditional ratchets, because of its design synchronized by torque lever (BB) deviations. The multiplier box (MM) does not escape being innovative as its design allows it to work in the reverse of traditional ones since it multiplies the RPM.

The main objective of the present invention is to provide a mechanical impulse engine with compressed air as a substitute for conventional diesel engine, gasoline or any other existing hydrocarbon and thus move rotors from generators and produce clean energy.

### Advantages of Invention

1. Provide a water pumping system in wells.
2. The engine does not store energy but has commercial generators produce it by our mechanical impulse engine without the need for conventional fuels.
3. The energy capacity produced by commercial generators driven by the engine will depend on the dimensions of the elements that make it up.
4. It should be noted in this system that the pneumatic piston body is enclosed in a pivoting metal lining so that impulse is not lost when the piston is triggered or retracted.
5. It provides an eco-friendly, low-cost, environmentally friendly system.

### BRIEF DESCRIPTION OF DRAWINGS

DRAWING 1.

(HH) It illustrates a sprocket driven by an attack wedge.

(BB) It illustrates a torque lever attached at one end to the mechanism (UU) containing the attack wedge.

(UU) It illustrates a mechanism containing a wedge that when rotated clockwise attacks the wheel teeth (HH) and in the anti-clockwise direction of the clock it slides.

(SS) It illustrates a metal lining that encloses the pneumatic piston's body (SS) with freedom of movement using a pivot.

(DD) Illustrates a piston that attaches at one end to the torque lever (BB)

(FF) Illustrates an air compressor that feeds the chambers of the pneumatic pistons.

(VV) It illustrates an air compressor that feeds the chambers of the pneumatic pistons.

(CC) Illustrates a concentric pulley with the sprocket (HH)

(KK) Illustrates a belt that attaches pulleys (DC) and (PP).

(NN) It illustrates a battery that powers the voltage inverter.

(QQ) Illustrates a voltage inverter from 12 VDC to 120 AC

(BA) Illustrates a start button.

(BS) Illustrates a STOP button.

DRAWING 2.

(MM) It illustrates an RPM multiplier box.

(OO) It illustrates a pulley coupled to the multiplier output (MM).

(WW) It illustrates an alternator that charges the battery.

(PP) It illustrates a pulley coupled with belt to the pulley (CC) and it is coupled to the input of a multiplier designed to increase the RPM.

(XX) It illustrates a concentric pulley to the pulley (00).

(CS) It illustrates a box enclosing the object of invention.

DRAWING 3

(UU) It is a synchronized mechanism that consists of a grade spring to execute at high speed and with symmetrical precision the tiling of the toothed plate (HH) clockwise.

### DETAILED DESCRIPTION OF THE INVENTION

It is the rotation of a central axle motivated by 2 two ratchets, rachet type, 2 lever arms of 1 meter, each arm is driven by a pneumatic piston that moves. It is powered by a 1 hp compressor, the ratchets being driven by the pistons move the shaft, in which a 24″ pulley is attached; in its final part it is connected to a pulley set until it reaches its 1800 rpm. In one of those pulleys it is connected to an alternator; which charges a battery.

This battery is connected to a 12 volts to 110 inverter and it energizes the air compressor, which feeds the pneumatic pistons with 140 psi giving and ensuring continuity to the permanent rotation of this axis, which in its sets of pulleys can be coupled to any generator, water type pump or compressors without having to use any type of fuel, such as gas, diesel, gasoline, sun, water, winds etc.

The use of the mechanic impulse motor by air compression to implement in generators, water type pump or compressors without having to use any type of fuel, such as gas, diesel, gasoline, sun, water, wind.

1-5. (canceled)

6. A mechanical impulse motor for producing kinetic rotational energy by driving a pulley using compressed air, comprising:
an air compressor powered by an electric battery;
two pneumatic pistons configured to received a compressed air from said air compressor;
two lever arms each of which is driven by one of said pneumatic pistons;
two ratchets each of which is driven by one of said level arms;
a shaft securely connected to said ratchets, driven by said lever arms to rotate in the direction constrained by the ratchets; and
a pulley securely connected to said shaft.

7. The mechanical impulse motor of claim 6, wherein said air compressor has a one horse power (1 HP).

8. The mechanical impulse motor of claim 7, wherein said air compressor feeds each of said two pneumatic pistons with a pressure of one hundred forty pound per square inch (140 psi).

9. The mechanical impulse motor of claim 8, wherein each of said pneumatic pistons further having a displacement of thirty millimeter (30 mm).

10. The mechanical impulse motor of claim 9, wherein each of said level arms further having a length of one meter (1 m).

11. The mechanical impulse motor of claim 6, wherein said shaft has a diameter of sixty millimeter (60 mm).

12. The mechanical impulse motor of claim 11, wherein said pulley has a diameter of twenty four inches (24 in), and further is connected to a system of pulleys resulting in a last pulley reaching one thousand eight hundred round per minutes (1800 rpm) in rotational speed.
